(19) United States
(12) Patent Application Publication
(10) Pub. No.: US 2026/0044323 A1
(43) Pub. Date: Feb. 12, 2026

(54) MATCHING SOURCE CODE TO AN EXECUTABLE PROGRAM

(71) Applicant: INTERNATIONAL BUSINESS MACHINES CORPORATION, Armonk, NY (US)

(72) Inventors: John Michael Chase, Keswick (CA); REID COPELAND, Ontario (CA); David Kevin Siegwart, Eastleigh (GB); Adam Strom, Toronto (CA)

(21) Appl. No.: 18/799,448

(22) Filed: Aug. 9, 2024

(51) Int. Cl. G06F 8/41

(52) U.S. Cl. CPC G06F 8/41

(57) ABSTRACT

A computer-implemented method for creating an intermediate representation (IR) of a source program by disassembling a compiled executable file and accessing source information describing the source program. In embodiments, the method further includes matching individual statements of the source program to corresponding portions of the IR of the source program, where the mapping is based at least in part on the source information and determining a source program line number for at least one constraint of a plurality of constraints based on the matching. In embodiments, the method further includes outputting the source program line number and any user variables for the at least one constraint.

### BACKGROUND

Aspects of the present invention relate generally to systems and methods for identifying problematic portions of a source program code.

A compiler is a specialized software tool that translates source code written in a high-level programming language into machine code or an intermediate form that can be executed by a computer's processor. This process involves several stages, including lexical analysis, syntax analysis, semantic analysis, optimization, and code generation. During these stages, the compiler checks for syntax and semantic errors, optimizes the code for performance and efficiency, and ultimately produces an executable program. The primary purpose of a compiler is to enable developers to write programs in human-readable languages while ensuring those programs can be efficiently executed by computer hardware.

Debugging code is the process of identifying, diagnosing, and fixing bugs or errors in a software program to ensure it runs as intended. This involves systematically examining the code to locate the source of problems, which can manifest as syntax errors, logical errors, or runtime errors. Tools such as debuggers, integrated development environments (IDEs), and logging frameworks are commonly used to assist in this process. Debugging typically includes setting breakpoints, stepping through code, inspecting variables, and analyzing the program's flow and state at various points of execution.

Performance tuning in software development involves the process of optimizing software to improve its efficiency, speed, and resource usage. This often includes identifying and addressing bottlenecks, reducing latency, enhancing throughput, and minimizing the consumption of system resources like memory and CPU. Techniques for performance tuning may involve refining algorithms, optimizing code, improving data structures, caching frequently accessed data, and employing efficient database queries. Performance tuning also includes profiling and monitoring to analyze the application's behavior under different conditions and workloads. The goal is to ensure that the software meets desired performance criteria.

### SUMMARY

In a first aspect of the invention, there is a computer-implemented method including: creating, by a processor set, an intermediate representation (IR) of a source program by disassembling a compiled executable file; accessing, by the processor set, source information describing the source program; matching, by the processor set, individual statements of the source program to corresponding portions of the IR of the source program, where the mapping is based at least in part on the source information; determining, by the processor set, a source program line number for at least one constraint of a plurality of constraints based on the matching; and outputting the source program line number for the at least one constraint.

In another aspect of the invention, there is a computer program product including one or more computer readable storage media having program instructions collectively stored on the one or more computer readable storage media. The program instructions are executable to: create an IR of a source program by disassembling a compiled executable file; access source information describing the source program; match individual statements of the source program to corresponding portions of the IR of the source program, where the mapping is based at least in part on the source information; determine a source program line number for at least one constraint of a plurality of constraints based on the matching; and output the source program line number for the at least one constraint.

In another aspect of the invention, there is a system including a processor set, one or more computer readable storage media, and program instructions collectively stored on the one or more computer readable storage media. The program instructions are executable to: create an IR of a source program by disassembling a compiled executable file; access source information describing the source program; match individual statements of the source program to corresponding portions of the IR of the source program, where the mapping is based at least in part on the source information; determine a source program line number for at least one constraint of a plurality of constraints based on the matching; and output the source program line number for the at least one constraint.

In a first aspect of the invention, there is a computer-implemented method including: obtaining, by a processor set, a compiled executable file from a data storage device; identifying, by the processor set, at least one underperforming portion of the compiled executable file; creating, by a processor set, an IR of a source program; mapping, by the processor set, individual statements of the source program to corresponding portions of the IR of the source program; determining, by the processor set, a source program line number and at least one user variable for at least one constraint of a plurality of constraints based on the mapping; and outputting the source program line number and the at least one user variable for a constraint related to the at least one underperforming portion of the compiled executable file.

In another aspect of the invention, there is a computer program product including one or more computer readable storage media having program instructions collectively stored on the one or more computer readable storage media. The program instructions are executable to: obtain a compiled executable file from a data storage device; identify at least one underperforming portion of the compiled executable file; create an IR of a source program; map individual statements of the source program to corresponding portions of the IR of the source program; determine a source program line number and at least one user variable for at least one constraint of a plurality of constraints based on the mapping; and output the source program line number and the at least one user variable for a constraint related to the at least one underperforming portion of the compiled executable file.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a block diagram of an exemplary environment in accordance with aspects of the present invention.

### DETAILED DESCRIPTION

Aspects of the present invention relate generally to systems and methods for identifying problematic portions of a source code for a source program and, more particularly, to matching a parsed representation of a source program to a disassembled representation of the corresponding executable program for accurately identifying problematic portions of the source code.

According to an aspect of the invention, there is a computer-implemented method and system for matching a parsed representation of a source program (source code) to a disassembled representation of the corresponding executable program. The method and system include: disassembling a compiled executable file (i.e., executable file) of the source program to create an IR of the source program; obtaining source information for the source program comprising a parse tree and symbol information (e.g., by parsing the source program); matching individual statements in the source program to corresponding families from the IR of the source program using the source information, where a family in the IR (e.g., an IR in the form of trees) that represents a single instance of a single statement in the source program; and determining a source program line number and user variables used in each family based on the matching. In embodiments, each family may be modeled as a constraint with a list of candidate line numbers. In embodiments, each family may be modeled as a list of candidate variables from the source program for each user variable used in a family.

According to an aspect of the invention, there is a computer-implemented method including: creating, by a processor set, an IR of a source program by disassembling a compiled executable file; accessing, by the processor set, source information describing the source program; matching, by the processor set, individual statements of the source program to corresponding portions of the IR of the source program, where the mapping is based at least in part on the source information; determining, by the processor set, a source program line number for at least one constraint of a plurality of constraints based on the matching; and outputting the source program line number for the at least one constraint. The foregoing features provide a method that overcomes problems in the existing technology by providing a method capable of matching a parsed representation of a source program to a disassembled representation of the corresponding executable program for accurately identifying problematic portions of the source code. Thereby creating a more efficient and a more cost-effective method for identifying and correcting issues within a source code, and as a result, improving the functioning of a computer and improving the technologies of software compiling, software debugging, and software performance tuning.

In embodiments, the computer-implemented method further includes accessing the compiled executable file at a remote device. By storing the compiled executable file and accessing the accessing the compiled executable file at a remote device, the method provides an ability to preserve local resources and take advantage of more robust remote resources.

In embodiments, the computer-implemented method further includes determining whether the at least one constraint may be coalesced with an additional constraint to form a single coalesced constraint. By coalescing the constraints into a single coalesced constraint, the method provides an ability to determine more information to better match the parsed representation of a source program to the disassembled representation of the corresponding executable program.

In embodiments, the computer-implemented method further includes determining whether a candidate symbol of the at least one constraint may be refined. By determining whether a candidate symbol may be refined, the method provides an ability to determine more information to better match the parsed representation of a source program to the disassembled representation of the corresponding executable program.

In embodiments, the computer-implemented method further includes determining whether a candidate line of the at least one constraint may be refined. By determining whether a candidate line may be refined, the method provides an ability to determine more information to better match the parsed representation of a source program to the disassembled representation of the corresponding executable program.

In embodiments, the computer-implemented method further includes propagating information describing the at least one constraint to other constraints of the plurality of constraints. By propagating information to other constraints, the method provides an efficient and computation-saving way for increasing the amount of information known about the other constraints.

In embodiments, the other constraints of the plurality of constraints are adjacent to the at least one constraint. By propagating information to other adjacent constraints, the method provides an efficient and computation-saving way for increasing the amount of information known about the other adjacent constraints.

According to an aspect of the invention, there is a computer program product including one or more computer readable storage media having program instructions collectively stored on the one or more computer readable storage media. The program instructions are executable to: create an IR of a source program by disassembling a compiled executable file; access source information describing the source program; match individual statements of the source program to corresponding portions of the IR of the source program, where the mapping is based at least in part on the source information; determine a source program line number for at least one constraint of a plurality of constraints based on the matching; and output the source program line number for the at least one constraint. The foregoing features provide a computer program product that overcomes problems in the existing technology by providing a method capable of match a parsed representation of a source program to a disassembled representation of the corresponding executable program for accurately identifying problematic portions of the source code. Thereby creating a more efficient and a more cost-effective method for identifying and correcting issues within a source code, and as a result, improving the functioning of a computer and improving the technologies of software compiling, software debugging, and software performance tuning

In embodiments, the computer program product further includes program instructions to access the compiled executable file at a remote device. By storing the compiled executable file and accessing the compiled executable file at a remote device, the computer program product provides an ability to preserve local resources and take advantage of more robust remote resources.

In embodiments, the computer program product further includes program instructions to determine whether the at least one constraint may be coalesced with an additional constraint to form a single coalesced constraint. By coalescing the constraints into a single coalesced constraint, the computer program product provides an ability to determine more information to better match the parsed representation of a source program to the disassembled representation of the corresponding executable program.

In embodiments, the computer program product further includes program instructions to determine whether a candidate symbol of the at least one constraint may be refined. By determining whether a candidate symbol may be refined, the computer program product provides an ability to determine more information to better match the parsed representation of a source program to the disassembled representation of the corresponding executable program.

In embodiments, the computer program product further includes program instructions to determine whether a candidate line of the at least one constraint may be refined. By determining whether a candidate line may be refined, the computer program product provides an ability to determine more information to better match the parsed representation of a source program to the disassembled representation of the corresponding executable program.

In embodiments, the computer program product further includes program instructions to propagate information describing the at least one constraint to other constraints of the plurality of constraints. By propagating information to other constraints, the computer program product provides an efficient and computation-saving way for increasing the amount of information known about the other constraints.

In embodiments, the other constraints of the plurality of constraints are adjacent to the at least one constraint. By propagating information to other adjacent constraints, the computer program product provides an efficient and computation-saving way for increasing the amount of information known about the other adjacent constraints.

According to an aspect of the invention, there is a system including a processor set, one or more computer readable storage media, and program instructions collectively stored on the one or more computer readable storage media. The program instructions are executable to: create an IR of a source program by disassembling a compiled executable file; access source information describing the source program; match individual statements of the source program to corresponding portions of the IR of the source program, where the mapping is based at least in part on the source information; determine a source program line number for at least one constraint of a plurality of constraints based on the matching; and output the source program line number for the at least one constraint. The foregoing features provide system that overcomes problems in the existing technology by providing a method capable of match a parsed representation of a source program to a disassembled representation of the corresponding executable program for accurately identifying problematic portions of the source code. Thereby creating a more efficient and a more cost-effective method for identifying and correcting issues within a source code, and as a result, improving the functioning of a computer and improving the technologies of software compiling, software debugging, and software performance tuning.

In embodiments, the system further includes program instructions to access the compiled executable file at a remote device. By storing the compiled executable file and accessing the accessing the compiled executable file at a remote device, the system provides an ability to preserve local resources and take advantage of more robust remote resources.

In embodiments, the system further includes program instructions to determine whether the at least one constraint may be coalesced with an additional constraint to form a single coalesced constraint and whether a candidate symbol of the at least one constraint may be refined. By coalescing the constraints into a single coalesced constraint, the system provides an ability to determine more information to better match the parsed representation of a source program to the disassembled representation of the corresponding executable program. By determining whether a candidate symbol may be refined, the system provides an ability to determine more information to better match the parsed representation of a source program to the disassembled representation of the corresponding executable program.

In embodiments, the system further includes program instructions to determine whether a candidate line of the at least one constraint may be refined. By determining whether a candidate line may be refined, the system provides an ability to determine more information to better match the parsed representation of a source program to the disassembled representation of the corresponding executable program.

In embodiments, the system further includes program instructions to propagate information describing the at least one constraint to other constraints of the plurality of constraints. By propagating information to other constraints, the system provides an efficient and computation-saving way for increasing the amount of information known about the other constraints.

In embodiments, the other constraints of the plurality of constraints are adjacent to the at least one constraint. By propagating information to other adjacent constraints, the system provides an efficient and computation-saving way for increasing the amount of information known about the other adjacent constraints.

According to an aspect of the invention, there is a computer-implemented method including: obtaining, by a processor set, a compiled executable file from a data storage device; identifying, by the processor set, at least one underperforming portion of the compiled executable file; creating, by a processor set, an IR of a source program; mapping, by the processor set, individual statements of the source program to corresponding portions of the IR of the source program; determining, by the processor set, a source program line number and at least one user variable for at least one constraint of a plurality of constraints based on the mapping; and outputting the source program line number and the at least one user variable for a constraint related to the at least one underperforming portion of the compiled executable file. The foregoing features provide a method that overcomes problems in the existing technology by providing a method capable of match a parsed representation of a source program to a disassembled representation of the corresponding executable program for accurately identifying problematic portions of the source code. Thereby creating a more efficient and a more cost-effective method for identifying and correcting issues within a source code, and as a result, improving the functioning of a computer and improving the technologies of software compiling, software debugging, and software performance tuning

In embodiments, the computer-implemented method further includes identifying at least one underperforming portion of the compiled executable file comprises identifying a plurality of underperforming portions of the compiled executable file. By identifying a constraint related to the at least one underperforming portion of the compiled executable file, the method provides users with additional information to help troubleshoot and fix the source code in efficient and cost-effective ways.

In embodiments, the computer-implemented method further includes ranking the plurality of underperforming portions of the compiled executable file that are causing greater performance issues. By ranking the underperforming portions of the compiled executable file, the method provides users with additional information to help troubleshoot and fix the source code and correct the performance issues in an efficient and cost-effective way.

According to an aspect of the invention, there is a computer program product including one or more computer readable storage media having program instructions collectively stored on the one or more computer readable storage media. The program instructions are executable to: obtain a compiled executable file from a data storage device; identify at least one underperforming portion of the compiled executable file; create an IR of a source program; map individual statements of the source program to corresponding portions of the IR of the source program; determine a source program line number and at least one user variable for at least one constraint of a plurality of constraints based on the matching; and output the source program line number and the at least one user variable for a constraint related to the at least one underperforming portion of the compiled executable file. The foregoing features provide a computer program product that overcomes problems in the existing technology by providing a method capable of match a parsed representation of a source program to a disassembled representation of the corresponding executable program for accurately identifying problematic portions of the source code. Thereby creating a more efficient and a more cost-effective method for identifying and correcting issues within a source code, and as a result, improving the functioning of a computer and improving the technologies of software compiling, software debugging, and software performance tuning.

In embodiments, the computer program product further includes identifying at least one underperforming portion of the compiled executable file comprises identifying a plurality of underperforming portions of the compiled executable file, and where the program instructions are further executable to rank the plurality of underperforming portions by determining which of the plurality of underperforming portions of the compiled executable file are causing greater performance issues. By identifying and ranking the underperforming portions of the compiled executable file, the method provides users with additional information to help troubleshoot and fix the source code in efficient and cost-effective ways.

In an exemplary use case, an enterprise common business-oriented language (COBOL) compiler may generate a compile executable file that accurately performs the operations specified in the source code. In other words, in some cases as noted above, the compiler and a code optimizer produce a suboptimal executable file because the source code or compiler options are suboptimal. For example, the default numeric type in COBOL is a printable string, which must be converted to another type to be used in a computation. Had the user chosen a different numeric type, the compiler would avoid the overhead of converting the number to and from a different format. Runtime options can also affect the performance of COBOL programs. Therefore, an executable file compiled by the COBOL compiler may suffer from performance issues. According to aspects of the invention, the methods, systems, and computer program products described herein may identify performance issues in the compiled executable file, match individual statements (e.g., lines, verbs, and symbols) of the source program to corresponding portions of the disassembled compiled executable file, and/or how much of an impact the identified performance issues has on application performance.

Implementations of the invention are necessarily rooted in computer technology. For example, the steps of creating an IR of a source program by disassembling a compiled executable file, matching individual statements of the source program to corresponding portions of the IR of the source program, determining a source program line number and at least one user variable for at least one constraint of a plurality of constraints based on the matching, and outputting the source program line number and the at least one user variable for the at least one constraint are computer-based and cannot be performed in the human mind.

Compilers generate machine-language code that accurately performs the operations specified in the source code. However, in some/many cases, the compiler produces suboptimal code because the source code or compiler options are suboptimal. For example, the default numeric type in a computer language may be based on a printable string, which must be converted to another data type to be used in a computation. For example, a signed zoned-decimal type is based on a printable string but is not completely printable as the sign code results in unintended display characters. However, had the user chosen a different numeric type in the source code, the compiler would avoid the overhead of converting the number to and/or from a different format. Runtime options can also affect the performance of programs. Many users wish to tune their programs and options in order to increase performance of their applications. When tuning performance, users may wish to focus first on the places where tuning is expected to give the biggest performance gains.

Performance tuning is a significant pain point for many users because finding performance issues in the source code of a source program is tedious, expensive, and often ineffective. Compilers and other tools can find performance issues through static analysis of source code, but users are unable to discern whether each of those issues actually impacts the overall execution time of their program. Some existing technologies can find hotspots, but hotspots are not always related to poor performance, and hotspots that are related to poor performance may be due to inefficient choices by the compiler rather than the user—so a user is rendered even more powerless unless they possess an intricate knowledge of the compiler being used. Further, existing technologies may disassemble the machine instructions in a hotspot, but the existing technologies are unable to, and do not, relate the disassembled machine instructions back to the source program.

According to aspects of the invention, a method may aid users in their performance tuning efforts by combining information from a profiler (e.g., performance profiler) with an analysis of the program. In embodiments, the systems and methods described herein may identify what each performance issue is, where it can be found in the source code, and how much of an impact the issue has on application performance, thereby identifying issues and helping users decide which issues to fix and which to ignore, as some users may only wish fix issues with a more significant impact. In embodiments, the systems and methods described herein combine information from the source code with information derived from a compiled program, such as profiling information which is based on the instructions in the compiled executable.

According to aspects of the invention, systems and methods report performance issues and indicate which part(s) of a source program (e.g., a statement, variables, etc.) are problematic and where to change the problematic code (e.g., which line of the source code for the source program). For example, a problem report might be “USAGE DISPLAY variable ZONED-ITEM was used in a computation on line 23456—using a PACKED-DECIMAL or BINARY variable in a computation is more efficient,” where USAGE DISPLAY, PACKED-DECIMAL, and BINARY are increasingly-efficient numeric datatypes. If the report did not have the line number, the user would have to search their code to find occurrences of the variable ZONED-ITEM. If the report did not have the variable name, the user would be directed to the line they need to change but would need to look elsewhere in the code to determine which variable on the line was USAGE DISPLAY type. And if the report had neither the line number nor variable name, it would be entirely unhelpful; the user would have no idea where to fix the problem.

In embodiments, the system and methods described herein address how to match a program's source code to a compiled version of the program. Embodiments describe a system and method for matching individual statements in a source program to corresponding families from the IR derived from disassembling a compiled executable, determining the line number and, in some embodiments, the user variables used in each family. In embodiments, constraint algorithms iteratively select a constraint and propagate its information to related constraints. This may cause those constraints to be refined (eliminating candidate values or causing them to have known values), which can trigger additional propagation. According to aspects of the invention, the systems and methods find a solution (e.g., a value for each variable) where all constraints are satisfied at once and none are violated. Upon termination, the system knows the line numbers corresponding to the satisfied constraints, as well as knowing some of that information for unsatisfied constraints that have satisfied subparts. In some embodiments, the system may know the user variable for the families when user variables are present.

Embodiments and aspects of the invention provide systems and methods that improve and advance the technology in a specific and practical application. In other words, the systems and methods described herein improve the functioning of a computer (enabling computers to operate more efficiently, process faster, etc.) and improve the technologies of software compiling, software debugging, and software performance tuning by providing more accurate data linking problematic areas of a compiled executable program to specific lines, symbols, verbs, etc., of the related source code of the source program.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the source program parsing and matching code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

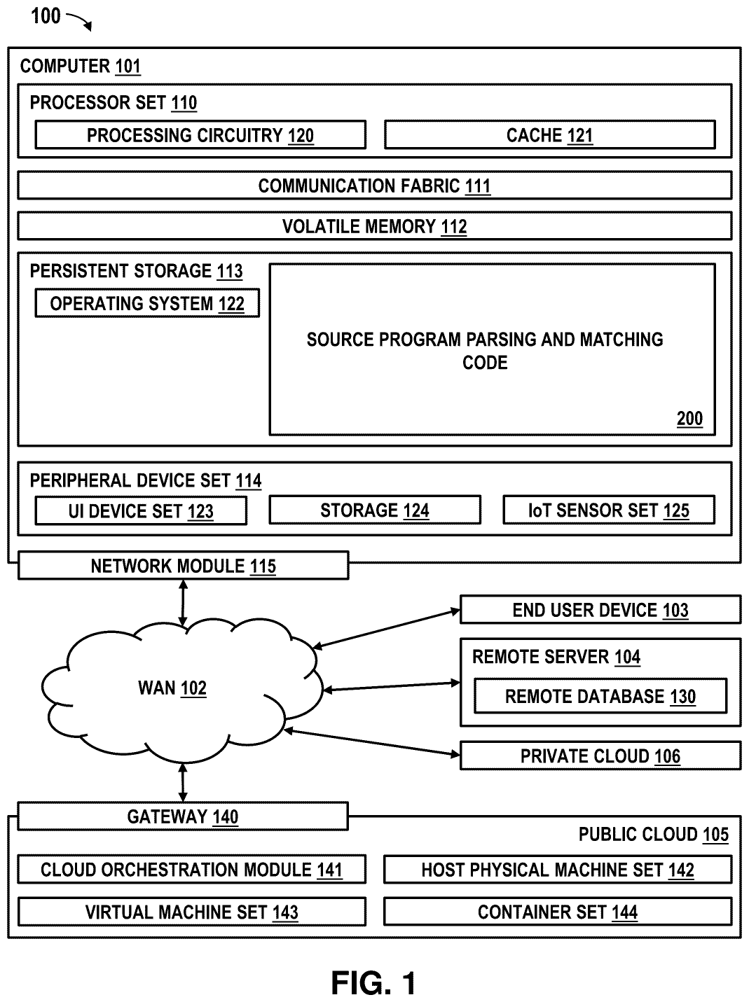

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

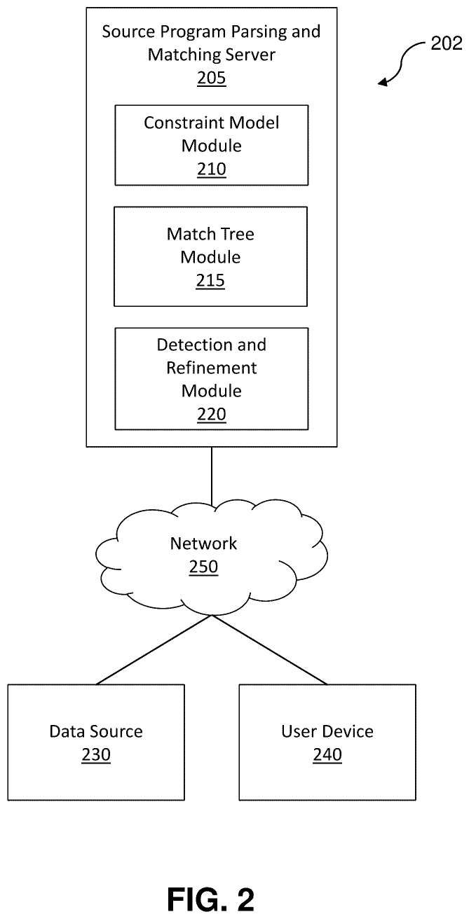

FIG. 2 shows a block diagram of exemplary environment 202 in accordance with aspects of the invention. In embodiments, environment 202 includes source program parsing and matching server 205, data source 230, user device 240, and network 250.

Source program parsing and matching server 205 may comprise one or more instances of computer 101 of FIG. 1. In another example, source program parsing and matching server 205 may comprise one or more virtual machines or containers running on one or more instances of computer 101 of FIG. 1. In embodiments, source program parsing and matching server 205 communicates with data source 230 and/or user device 240 via network 250, which may comprise WAN 102 of FIG. 1. In embodiments, data source 230 comprises one or more data sources each comprising an instance of remote database 130 and/or remote server 104 of FIG. 1. In embodiments, user device 240 comprises one or more instances of end user device 103 of FIG. 1. There may be plural different instances of user device 240 including, for example, a server, a cloud management terminal, a personal computer, a tablet, a smartphone, and more. The different instances of user device 240 may be used by different users and evaluators, respectively.

In embodiments, source program parsing and matching server 205 of FIG. 2 comprises constraint model module 210, match tree module 215, and detection and refinement module 220, each of which may comprise modules of source program parsing and matching code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the invention as described herein. These modules of source program parsing and matching code of block 200 are executable by computer 101 of FIG. 1 (e.g., processing circuitry 120 of FIG. 1) to perform the inventive methods as described herein. Source program parsing and matching server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, source program parsing and matching server 205 is configured to access a compiled executable file of a source program. In embodiments, the compiled executable file may be accessed by receiving the compiled executable file from a data source (such as data source 230 of FIG. 2) and/or a user device (such as user device 240 of FIG. 2). In additional embodiments, the compiled executable file may be accessed by obtaining the compiled executable file by accessing a data source (such as data source 230 of FIG. 2) and/or a user device (such as user device 240 of FIG. 2). In additional embodiments, the compiled executable file may be stored locally.

As used herein, a compiled executable program (e.g., a source program) is a software application that has been converted from its source code form into a binary format that a computer processor can directly execute. Furthermore, as used herein, source code is the code written by a programmer using a programming language before it has been compiled or interpreted into machine code, thereby creating a compiled executable program (e.g., a source program). This code contains the instructions and logic that define how the source program (e.g., software application) operates.

In embodiments, source program parsing and matching server 205 is further configured to create an IR of the source program by disassembling the compiled executable file. The IR may comprise families, trees, line number information, and symbol information.

As used herein, an IR is a disassembled version of a previously-compiled program. In embodiments, the system uses files describing the IR to obtain information about a program. For example, files describing the IR may be, or may comprise, a file that contains specific record information about the program that is collected during assembly and may contain information such as a parse tree, symbol information, and other data about a program. Files describing the IR and/or other files may be generated by a compiler's parser (such as a COBOL compiler's parser) and may be consumed by an analysis tool to gain understanding/information about the source program. Accordingly, source program parsing and matching server 205 is configured to work with one or more representations of the same program. That is, it works with a compiled executable file, a source program, and/or an IR of the source program that are all representations of the same program. In embodiments, the files describing the IR may be an ADATA file produced by a COBOL profiler.

In accordance with aspects of the invention, constraint model module 210 is configured to create an IR of the source program by disassembling the compiled executable file. In embodiments, a disassembled executable file comprises at least one constraint where each constraint contains information about a family. As used herein, a family is a tree, a set of trees, or an equivalent, or another IR, that fully represents a single instance of a single statement within a source code. In embodiments, there may be more than one family corresponding to a line of code if the line of code was part of a unit that was inlined (i.e., a line inserted within another context) more than once.

For example, compilers may inline both compiler-generated methods and other user programs into a program, replacing a call with the body of the program. Thus, the parse tree must reflect the possibility of inlined programs, and also of multiple levels of inlining. If program C is inlined into program B and program B is inlined into program A, the IR for program A will contain IR for program B and program C as well. Inlined programs are handled by recursively finding calls to user programs in the current parse tree, including any alternative parse trees for a node. When such a call is found, if the call does not already have an alternative parse tree, the parse tree for the called program is added as an alternative to the call node. This allows the match tree to match the parse tree for either the call node or the body of the inlined program. As used herein, a match tree may consist of nodes with the same fields and properties as the parse tree and may be constructed by performing a depth-first walk of the IR tree and then, using an algorithm similar to a parser, determining at each node, when possible, which possible verbs are represented in the parse tree.

As used herein, a line of source code is a pairing that includes a line number and a statement number associated with the line number. In embodiments, the line number may start at 1, however, other embodiments may provide unique values or may start at another number. For example, any type of compiler-generated code (such as program prologue code or epilogue code) may provide unique values for the lines of compiled code.

In embodiments, constraint model module 210 may disassemble the compiled executable file, creating an IR of the compiled executable file such that constraints are created for each family/tree (e.g., an IR tree or IR trees) of the IR. In such embodiments, constraints may comprise a line (or line part), a verb part (or verb), and/or a symbol part (or symbol). As used herein, a line part is a list of candidate line numbers: line number and statement number pairs; a verb part is a list of candidate verbs, where each verb is given a unique number; and a symbol part is a list of symbols in the IR, each with a list of candidate source symbols for the IR symbol. Therefore, in embodiments disassembling the compiled executable file include creating an IR of the compiled executable file, the IR having constraints that comprise candidate lines, verbs, and symbols.

With respect to the verb part, some languages may refer to a verb part as keywords instead of verbs. In embodiments, functions that are part of a language or implemented in its runtime (e.g., the “printf( )” function in the C language) may be treated as separate verbs. In other embodiments functions may be treated as a single CALL verb. In such embodiments, calls to other programs may similarly be treated as a CALL verb.

In embodiments, constraint model module 210 is further configured to initialize constraints with candidate information for some or all parts of the constraint. For example, candidate verbs may be determined from the semantic information gained when constructing a match tree. Candidate lines for a constraint are set if the client supplies a compiler listing which indicates the line for some or all instructions. As the parse trees are generated from the instructions, the line for an instruction is a candidate line for the first tree that uses that instruction. In cases where the line number is known but there are multiple possible statements and the specific statement is not known, each valid line-statement pair is added as a candidate; otherwise, if the statement number is known, it too is used.

In accordance with aspects of the invention, match tree module 215 is configured to construct a separate data structure from a parse tree called a match tree, which is used to structurally match against the parse tree for any given line. As provided above, in embodiments, a match tree may consist of nodes with the same fields and properties as the parse tree. In embodiments, the match tree is constructed by performing a depth-first walk of the IR tree and then, using an algorithm similar to a parser, determining at each node, when possible, which possible verbs are represented in the parse tree. In embodiments, context is maintained in the constructed match tree. In embodiments, examples of match tree instruction may include constructions such that loads, stores, and arithmetic operation nodes that are not part of an address computation, exist as-is in the match tree. In embodiments, address computations may be ignored if they contribute to a simple address, such as a variable that is a known offset on the stack or from the base of the heap. In such embodiments, the parse tree would not contain a simple address computation, therefore the match tree should not contain a simple address computation either. In embodiments, address computations may be transformed into something else, such as array accesses, where the IR may have a computation to find the base address in the array and an additional computation to find the offset into the array. In other embodiments, nodes that clean results may be implied by, but do not always exist as separate entities in, the parse tree, and so they should not exist in the match tree either. For example, COBOL IR contains operations to set/clean the sign code of a packed decimal value. The compiler generates this operation in keeping with language rules and the operation does not explicitly exist in the COBOL source or the parse tree.

In accordance with aspects of the invention, detection and refinement module 220 is configured to match (e.g., map) individual statements in the source program to corresponding portions in the IR of the source program based at least in part on the source information. As used herein, a statement is a unit of a programming language that expresses some task or action to be carried out. For example, a statement could be “x=30” or “CALL Larger (a, b, c),” where the first statement performs the action of assigning the variable x with a value of 30 and the second statement calls a subroutine Larger( ) and passes the values of a, b, and c to the subroutine.

Further, as used herein, source information describes the source program. For example, in embodiments, the source information is the source code for the source program. In other embodiments, the source information may be broken down (or summarized) into lines and symbols.

The matching/mapping may be completed using one or more of a family detection process, a symbol detection process, a line refinement process, and/or a line propagation process.

A family detection process may coalesce nearby related constraints by merging the separate constraints into one constraint and/or determine if a family is closed (i.e., if all trees that can be grouped or coalesced into the family have been added). In embodiments, coalescing nearby constraints is done by looking for relationships between nearby parse trees. In such embodiments, these constraints may be located within a single basic block, or they may span several basic blocks (e.g., statements having multiple clauses, such as an IF statement).

In embodiments, detection and refinement module 220 uses the family detection process which allows for constraints to be merged once detection and refinement module 220 of FIG. 2 begins matching/mapping individual statements in the source program to corresponding portions in the IR of the source program. Further, this allows detection and refinement module 220 to use the open/closed status of a family to indicate when it might be safe to propagate line information to and from a constraint. These features provide a more robust and a more accurate method of matching/mapping statements.

In embodiments, detection and refinement module 220 is configured to use the symbol detection process for matching IR symbols to source symbols, and accounts for one or more problems, including the following: a first possible problem is that the bounds of a variable may be exceeded. When given an offset within a group or an offset relative to a base address, detection and refinement module 220 cannot determine with any surety whether the variable in question is one that directly overlaps the offset or one that is entirely before the offset and whose bounds have exceeded, without context. A second possible problem is that if detection and refinement module 220 does not know how a storage type has been laid out, an IR symbol of that type could be any source symbol of that storage type that has a compatible datatype with the IR symbol, which opens detection and refinement module 220 to unknown or incorrectly identified symbol matches. More specifically, a variable can exist in various storage types that determine aspects of how a backing memory for the variable is stored, retrieved, initialized, located or otherwise processed. For example, storage types may include static storage, local storage, storage for passing/receiving function arguments, data for particular language statements, compiler or runtime allocated storage, and more.

A third possible problem is that if detection and refinement module 220 does not know the layout of a storage type, detection and refinement module 220 cannot determine without context, whether a stack-based or heap-based variable of such a storage type is a user variable or a compiler-generated variable, which also opens detection and refinement module 220 to unknown or incorrectly identified symbol matches.

In embodiments, the line refinement process is where detection and refinement module 220 refines the list of candidate lines for a constraint. In embodiments where no candidate lines have been set for a constraint and where the family is closed, if a source line matches the constraint, the line is added to the constraint's candidate set of lines. In embodiments where candidate lines have been set for a constraint, detection and refinement module 220 is configured to check that the line still matches the constraint. If a line no longer matches the constraint, the line is removed from the set of candidate lines.

In embodiments, detection and refinement module 220 is configured to use a line propagation process to propagate a constraint's lines to adjacent constraints (i.e., those whose trees are directly adjacent to trees in this constraint's family). This is done so line information about one constraint can be used to refine line information for other constraints. In other words, as more and more line information is discovered/determined, that information can be used to solve and/or determine more information about the other constraints, one constraint at a time.

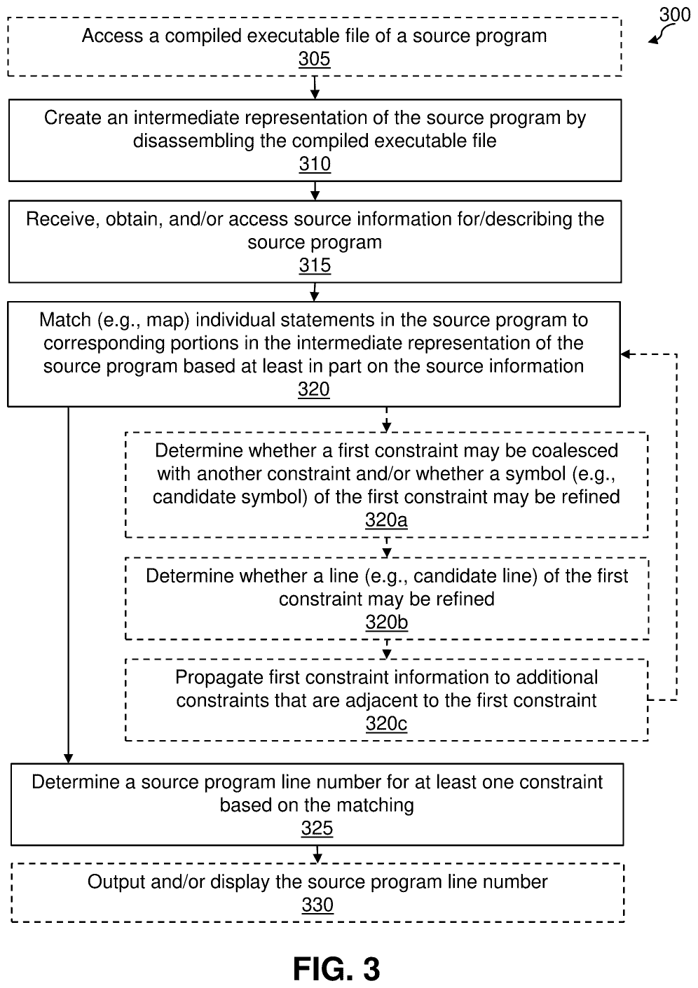

FIG. 3 shows a flowchart of exemplary method 300 in accordance with aspects of the present invention. Steps of the method may be carried out in the environment of FIG. 2 and are described with reference to elements depicted in FIG. 2. It should be noted that, for simplicity, FIG. 3 illustrates a possible path for a first constraint (e.g., blocks 320a-c). However, in embodiments, the flowchart of FIG. 3 may be applied to multiple constraints, including up to tens, hundreds, thousands, and/or millions of constraints, at any given time. In such embodiments, each of the tens, hundreds, thousands, and/or millions of constraints may be processed in series or in parallel by one or more processors on one or more servers (e.g., one or more instances of source program parsing and matching server 205 of FIG. 2).

At block 305 of FIG. 3, source program parsing and matching server 205 is optionally configured (as indicated by the dashed lines) to access a compiled executable file of a source program. As noted above, in embodiments, the compiled executable file may be accessed by receiving the compiled executable file from a data source (such as data source 230 of FIG. 2) and/or a user device (such as user device 240 of FIG. 2). In additional embodiments, the compiled executable file may be accessed by obtaining the compiled executable file by accessing a data source (such as data source 230 of FIG. 2) and/or a user device (such as user device 240 of FIG. 2). In additional embodiments, the compiled executable file may be stored locally.

At block 310, constraint model module 210 of FIG. 2 is configured to create an IR of the source program by disassembling the compiled executable file. In embodiments, a disassembled executable file comprises at least one constraint where each constraint contains information about a family. As used herein, a family is a tree, a set of trees, or an equivalent, or another IR, that fully represents a single instance of a single statement within a source code. In embodiments, there may be more than one family corresponding to a line of code if the line of code was part of a unit that was inlined (i.e., a line inserted within another context) more than once.

As noted above, in embodiments, constraint model module 210 may disassemble the compiled executable file such that constraints are created for each family/tree (e.g., an IR tree or IR trees). In such embodiments, constraints may comprise a line (or line part), a verb part (or verb), and a symbol part (or symbol).

In embodiments, block 310 may further comprise constructing a separate data structure from a parse tree called a match tree, which is used to structurally match against the parse tree for any given line, as described above. In such embodiments, match tree module 215 of FIG. 2 may construct the match tree.

At block 315, source program parsing and matching server 205 of FIG. 2 is configured to receive, obtain, and/or access source information for (e.g., describing) the source program. For example, as provided above, in embodiments, the source information is the source code for the source program. In other embodiments, the source information may be broken down (or summarized) into lines and symbols.

At block 320, detection and refinement module 220 of FIG. 2 is configured to match/map individual statements in the source program to corresponding portions in the IR of the source program based at least in part on the source information. In embodiments, matching (e.g., mapping) individual statements are completed by performing one or more of the features of blocks 320a-c.

At block 320a, detection and refinement module 220 is optionally configured to determine whether a first constraint may be coalesced with another constraint (or constraints) to form a single coalesced constraint and/or whether a symbol (e.g., a candidate symbol) of the first constraint may be refined. In embodiments, detection and refinement module 220 may determine whether a first constraint may be coalesced with nearby related constraints using a family detection process. If at block 320a detection and refinement module 220 does not determine whether a first constraint can be coalesced with another constraint (or constraints) or whether a candidate symbol of the first constraint may be refined, the first constraint is set aside until more information is available that might help map the first constraint.

As noted above, in embodiments, a family detection process may coalesce nearby related constraints into one constraint, and/or determine if a family is closed (i.e., if all trees that can be grouped, merged, or coalesced into the family have been added). In embodiments, coalescing nearby constraints is done by looking for relationships between nearby parse trees. In such embodiments, these constraints are located within a single basic block, or they may span several basic blocks (e.g., statements having multiple clauses, such as an IF statement).

In embodiments, trees are grouped, merged, or coalesced, by looking for specific connections between them. For example, the family detection process will match a tree that stores to a particular parameter area with another tree that executes a CALL statement using that particular/same parameter area. In embodiments, merging constraints also results in match trees being changed and merged to reflect the behavior of the family as a whole.

In embodiments, the family detection process considers all trees in a block (or for all adjacent blocks, for families that might span multiple basic blocks) to ensure that all relevant trees are included in the family. For example, when the family detection process determines that there are no other/additional trees that can be included, either because all other candidates are in closed families, do not match a pattern, and/or are not part of the current family, the current family is marked as closed. Prior to that, the family is open. In embodiments, the family detection process ignores trees in closed families. In such embodiments, information can only be propagated to and from constraints with closed families, to avoid propagating incorrect information (such as propagating that a tree setting up a parameter for a call is a MOVE when it is actually part of a CALL).

The family detection process thus allows for constraints to be merged once the detection and refinement module 220 of FIG. 2 begins matching/mapping individual statements in the source program to corresponding portions in the IR of the source program. Further, this allows detection and refinement module 220 to use the open/closed status of a family to indicate when it might be safe to propagate line information to and from a constraint. These features provide a more robust and a more accurate method of matching/mapping statements.

As noted above, at block 320a detection and refinement module 220 is optionally configured to determine whether a symbol (e.g., candidate symbol) of the first constraint may be refined. As provided above, in embodiments, this determination is made using a symbol detection process which matches IR symbols to source symbols, and accounts for one or more problems, as provided above.

Detection and refinement module 220 overcomes these problems and provides an improvement to the symbol detection technologies. In embodiments where a constraint has two or more candidate lines and the IR symbol's candidate source symbols list is empty, then detection and refinement module 220 walks the parse tree and the match tree in parallel. Walking the parse tree and the match tree in parallel may include checking (at each node) whether the nodes match (i.e., same datatype, same size, same storage type, and/or same offset within the storage type or group). If any pair of nodes (e.g., symbols) does not match, detection and refinement module 220 stops because symbol does not match the constraint. If all pairs of nodes (e.g., symbols) match, the source symbol does match the constraint. In embodiments, any source symbol that could possibly match the IR symbol, based on position in the match tree, becomes a candidate source symbol for the IR symbol.

In embodiments where a constraint has two or more candidate lines and the IR symbol already has candidates, then detection and refinement module 220 builds a new list of candidates by walking the parse tree and the match tree in parallel, as described above. In this manner, the IR symbol's candidate list becomes the intersection of the new list of candidates and the previous list of candidates.

In embodiments where a constraint has one candidate line and the IR symbol's candidate source symbols list is empty, then detection and refinement module 220 walks the parse tree and the match tree in parallel, as described above. When there is a match tree for the constraint, detection and refinement module 220 walks the parse tree and match tree for each candidate line in parallel and any source symbol that could possibly match the IR symbol, based on position in the match tree, becomes a candidate source symbol for the IR symbol. In embodiments, when a source symbol exceeds its bounds, if the source symbol could possibly match the IR symbol, detection and refinement module 220 adds the symbol as a candidate.

In embodiments, detection and refinement module 220 makes a list (i.e., a use count or use count list) of all source symbols on the line and determines a count (e.g., a number) of the number of times each symbol is used in the statement. Detection and refinement module 220 iterates until there is no change in an iteration, all IR symbols are matched, and/or all source symbols are matched. Detection and refinement module 220 may then iterate over every remaining unmatched IR symbol in the family of trees and if the IR symbol has only one remaining candidate symbol, a match between the IR symbol and the source symbol is made, the use count for the source symbol is decremented, and if the source symbol's use count becomes 0 (zero), remove the symbol from the candidate list for every other IR symbol.

At block 320b, detection and refinement module 220 is optionally configured to determine whether a line (e.g., candidate line) of the first constraint may be refined using a line refinement process. If after the line refinement process the constraint's candidate line is unchanged, the constraint is set aside.

As provided above, the line refinement process is where detection and refinement module 220 refines the list of candidate lines for a constraint. In embodiments where no candidate lines have been set for a constraint and where the family is closed, if a source line matches the constraint, the line is added to the constraint's candidate set of lines. In embodiments where candidate lines have been set for a constraint, detection and refinement module 220 is configured to check that the line still matches the constraint. If a line no longer matches the constraint, the line is removed from the set of candidate lines. In embodiments that use programming languages that are long and use relatively few verbs (e.g., COBOL), a threshold may be set where if the size of a set of lines exceeds the threshold, detection and refinement module 220 will not attempt to match any of the source lines against the constraint. In embodiments, thresholds may also be set for a number of candidate lines. In other words, when the number of initial candidate lines exceeds a threshold amount, detection and refinement module 220 does not set any initial candidates for the constraint until the number of candidate lines is less than the threshold amount.

At block 320c, detection and refinement module 220 is optionally configured to propagate first constraint information to additional constraints that are adjacent to the first constraint using a line propagation process. If the line propagation process causes any of the adjacent constraint's line information to be refined, the adjacent constraints are processed in accordance with blocks 320a-b.

At block 325, source program parsing and matching server 205 is configured to determine a source program line number for each constraint, coalesced constraint, or family of each constraint based on the matching. In embodiments, block 325 may further include identifying families that are related to portions of the compiled executable file that are underperforming. In other words, using the determined source program line number for each constraint, coalesced constraint, or family, source program parsing and matching server 205 may identify the lines of code in the source program that are negatively affecting the performance of the compiled executable program. In embodiments, source program parsing and matching server 205 may use information from the constraints to further identify the user variables used in each line of code in the source program that negatively affects the performance of the compiled executable program. In embodiments, source program parsing and matching server 205 is configured to rank the underperforming portions of the compiled executable file by determining which of the underperforming portions of the compiled executable file are causing more serious performance issues. In embodiments, the underperforming portions may be more serious and may have a greater impact on performance and may therefore have a relatively high impact score. In other embodiments, an underperforming portion of the compiled executable file may be less serious but due to a relatively high frequency of execution it may have a relatively high impact score due to the cumulative nature of the underperforming portions of the compiled executable file. In this manner, source program parsing and matching server 205 may rank the underperforming portions of the compiled executable file.

At block 330, source program parsing and matching server 205 is configured to output and/or display the determined source program line number and variable. In embodiments, block 330 may further include outputting, displaying, and/or highlighting the lines of code in the source program that are negatively affecting the performance of the compiled executable program. In embodiments, source program parsing and matching server 205 is configured to output a ranked list of underperforming portions of the compiled executable file and the constraints that map to the underperforming portions, to further identify which lines of code in the source program, if fixed, would have a greater impact on improving the functioning of the compiled executable program. In short, the system may determine a line number and any user variables used, when user variables are used, related to problems found in the compiled executable program. That is, if a problem is found, and the IR trees for that problem correspond to a particular constraint, the system can use information from that constraint about the line number and user variables in the family to indicate the line number and user variables causing, or affected by, the problem(s) found in the compiled executable program. In this manner, outputting, displaying, highlighting the lines of code in the source program that are negatively affecting the performance of the compiled executable program, and ranking the underperforming portions of the compiled executable file and the constraints that map to the underperforming portions is an improvement over existing technologies and results in programs that operate more efficiently and at cheaper costs and it leads to the overall improvement in the functioning of a computer and a computer program.

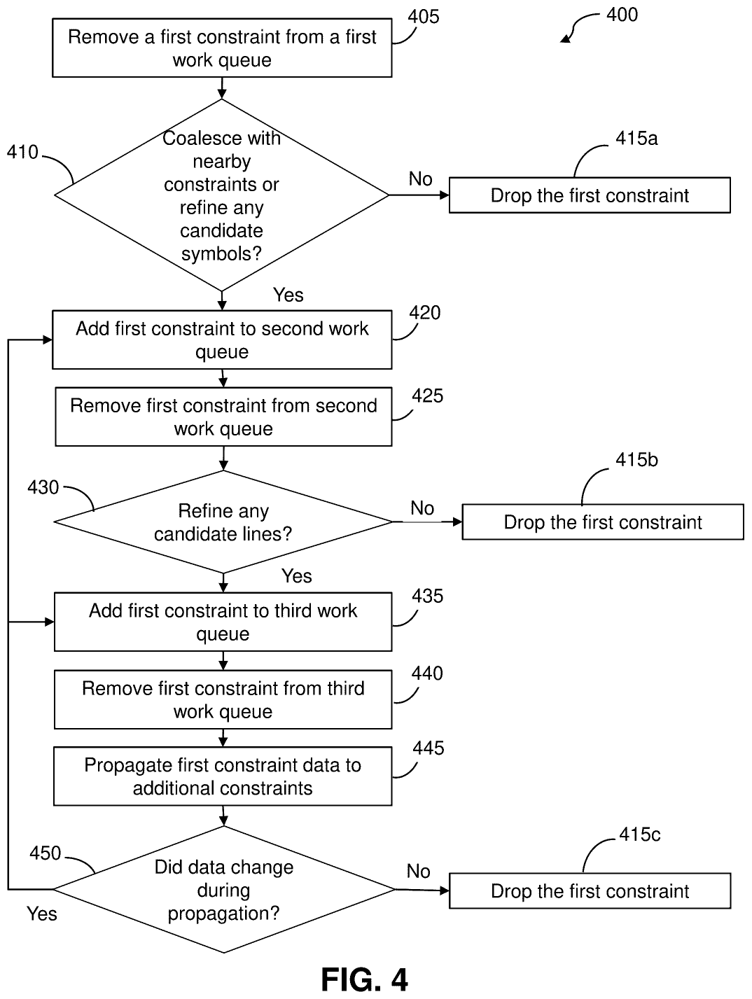

FIG. 4 shows a flow diagram of an exemplary environment 400 in accordance with aspects of the present invention. At least portions of environment 400 may be described with reference to some elements and actions depicted in FIGS. 2 and 3. It should be noted that, for simplicity, FIG. 4 traces a possible path for a single constraint. However, in embodiments, the flow diagram of FIG. 4 may be applied to multiple constraints, including up to tens, hundreds, thousands, and/or millions of constraints, at any given time. In such embodiments, each of the tens, hundreds, thousands, and/or millions may be processed in parallel by one or more processors on one or more systems (e.g., one or more instances of source program parsing and matching server 205 of FIG. 2).

At block 405, the system (which may be an instance of source program parsing and matching server 205 of FIG. 2 or detection and refinement module 220 of FIG. 2) removes a first constraint from a first work queue. As noted above, the flow diagram of FIG. 4 may be applied to tens, hundreds, thousands and/or millions of constraints. In such embodiments, block 405 may be performed by one or more processors until every constraint has been removed from the first work queue. In embodiments, constraints that have not yet been resolved and are not in the second or third work queues, are placed in the first work queue.

At block 410, the system determines whether the first constraint can be coalesced with nearby constraints or whether the system can refine any symbols. In embodiments, block 410 is completed in accordance with block 320a of FIG. 3. In embodiments, the flow diagram of FIG. 4 may be applied to tens, hundreds, thousands, and/or millions of constraints. In such embodiments, block 410 may be performed by one or more processors until every constraint has been removed from the first work queue at block 405. In other words, block 410 will be performed until there are no more constraints removed from the first work queue at block 405.

Thus, the system loops until the first work queue is empty, removing constraints one at a time, coalescing with nearby constraints into a single constraint, and/or refining symbols.

If the first constraint cannot be coalesced with nearby constraints or cannot refine any candidate symbols, the constraint is dropped at block 415a. In embodiments, dropping the constraint at 415a further includes moving the constraint to the first work queue for further processing. If the constraint can be coalesced with nearby constraints or a candidate symbol can be refined, the constraint is added to a second working queue at block 420.

At block 425, the system removes the first constraint from the second work queue. As noted above, the flow diagram of FIG. 4 may be applied to tens, hundreds, thousands, and/or millions of constraints. In such embodiments, block 425 may be performed by one or more processors until every constraint has been removed from the second work queue.

At block 430, the system determines whether any of the candidate lines may be refined. In embodiments, block 430 is completed in accordance with block 320b of FIG. 3. In embodiments, the flow diagram of FIG. 4 may be applied to tens, hundreds, thousands, and/or millions of constraints. In such embodiments, block 430 may be performed by one or more processors until every constraint has been removed from the second work queue at block 425. In other words, block 430 will be performed (e.g., loops) until there are no more constraints removed from the second work queue at block 425.

If none of the candidate lines can be refined, the constraint is dropped at block 415b. In embodiments, dropping the constraint at 415b further includes moving the constraint to the first work queue for further processing. If at least one candidate line can be refined at block 430, the constraint is added to a third working queue at block 435.

At block 440, the system removes the first constraint from the third work queue. As noted above, the flow diagram of FIG. 4 may be applied to tens, hundreds, thousands, and/or millions of constraints. In such embodiments, block 440 may be performed by one or more processors until every constraint has been removed from the third work queue.

At block 445, the system propagates the first constraint data to additional constraints. In embodiments this is completed in accordance with block 320c of FIG. 3. In embodiments, the flow diagram of FIG. 4 may be applied to tens, hundreds, thousands, and/or millions of constraints. In such embodiments, block 445 may be performed by one or more processors until every constraint has been removed from the third work queue at block 440. In other words, block 445 will be performed (e.g., loops) until there are no more constraints removed from the second work queue at block 440.

At block 450, the system determines whether any data changed during the propagation at block 445. If none of the data changed during propagation, the constraint is dropped at block 415c. In embodiments, dropping the constraint at 415c further includes moving the constraint to the first work queue for further processing. If at least some data changed during the propagation, the constraint is added to the first and/or second working queues for additional processing.

In embodiments, any block of FIG. 4 may be performed at the same time as any one or more of the other blocks illustrated in FIG. 4. For example, a first constraint may be processed according to block 445 while a second constraint is processed according to block 430 and while a third constraint is processed according to block 405.

In embodiments, a service provider could offer to perform the processes described herein. In this case, the service provider can create, maintain, deploy, support, etc., the computer infrastructure that performs the process steps of aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, aspects of the invention provide a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system may include one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
creating, by a processor set, an intermediate representation of a source program by disassembling a compiled executable file;
accessing, by the processor set, source information describing the source program;
matching, by the processor set, individual statements of the source program to corresponding portions of the intermediate representation of the source program, wherein the matching is based at least in part on the source information;
determining, by the processor set, a source program line number for at least one constraint of a plurality of constraints based on the matching; and
outputting the source program line number for the at least one constraint.

2. The computer-implemented method of claim 1, further comprising accessing the compiled executable file at a remote device.

3. The computer-implemented method of claim 1, further comprising determining whether the at least one constraint may be coalesced with an additional constraint to form a single coalesced constraint.

4. The computer-implemented method of claim 1, further comprising determining whether a candidate symbol of the at least one constraint may be refined.

5. The computer-implemented method of claim 1, further comprising determining whether a candidate line of the at least one constraint may be refined.

6. The computer-implemented method of claim 1, further comprising propagating information describing the at least one constraint to other constraints of the plurality of constraints.

7. The computer-implemented method of claim 6, wherein the other constraints of the plurality of constraints are adjacent to the at least one constraint.

8. A computer program product comprising one or more computer readable storage media having program instructions collectively stored on the one or more computer readable storage media, the program instructions executable to:
create an intermediate representation of a source program by disassembling a compiled executable file;
access source information describing the source program;
match individual statements of the source program to corresponding portions of the intermediate representation of the source program, wherein the matching is based at least in part on the source information;
determine a source program line number for at least one constraint of a plurality of constraints based on the matching; and
output the source program line number for the at least one constraint.

9. The computer program product of claim 8, wherein the program instructions are further executable to access the compiled executable file at a remote device.

10. The computer program product of claim 8, wherein the program instructions are further executable to determine whether the at least one constraint may be coalesced with an additional constraint to form a single coalesced constraint.

11. The computer program product of claim 8, wherein the program instructions are further executable to determine whether a candidate symbol of the at least one constraint may be refined.

12. The computer program product of claim 8, wherein the program instructions are further executable to determine whether a candidate line of the at least one constraint may be refined.

13. The computer program product of claim 8, wherein the program instructions are further executable to propagate information describing the at least one constraint to other constraints of the plurality of constraints.

14. The computer program product of claim 13, wherein the other constraints of the plurality of constraints are adjacent to the at least one constraint.

15. A system comprising:
a processor set, one or more computer readable storage media, and program instructions collectively stored on the one or more computer readable storage media, the program instructions executable to:
create an intermediate representation of a source program by disassembling a compiled executable file;
access source information describing the source program;
match individual statements of the source program to corresponding portions of the intermediate representation of the source program, wherein the matching is based at least in part on the source information;
determine a source program line number for at least one constraint of a plurality of constraints based on the matching; and
output the source program line number for the at least one constraint.

16. The system of claim 15, wherein the program instructions are further executable to access the compiled executable file at a remote device.

17. The system of claim 15, wherein the program instructions are further executable to determine whether the at least one constraint may be coalesced with an additional constraint to form a single coalesced constraint and whether a candidate symbol of the at least one constraint may be refined.

18. The system of claim 15, wherein the program instructions are further executable to determine whether a candidate line of the at least one constraint may be refined.

19. The system of claim 18, wherein the program instructions are further executable to propagate information describing the at least one constraint to other constraints of the plurality of constraints.

20. The system of claim 19, wherein the other constraints of the plurality of constraints are adjacent to the at least one constraint.

21. A computer-implemented method, comprising:
obtaining, by a processor set, a compiled executable file from a data storage device;
identifying, by the processor set, at least one underperforming portion of the compiled executable file;
creating, by a processor set, an intermediate representation of a source program;
mapping, by the processor set, individual statements of the source program to corresponding portions of the intermediate representation of the source program;
determining, by the processor set, a source program line number and at least one user variable for at least one constraint of a plurality of constraints based on the mapping; and
outputting the source program line number and the at least one user variable for a constraint related to the at least one underperforming portion of the compiled executable file.

22. The computer-implemented method of claim 21, wherein identifying at least one underperforming portion of the compiled executable file comprises identifying a plurality of underperforming portions of the compiled executable file.

23. The computer-implemented method of claim 22, further comprising ranking the plurality of underperforming portions by determining which of the plurality of underperforming portions of the compiled executable file are causing greater performance issues.

24. A computer program product comprising one or more computer readable storage media having program instructions collectively stored on the one or more computer readable storage media, the program instructions executable to:
obtain a compiled executable file from a data storage device;
identify at least one underperforming portion of the compiled executable file;
create an intermediate representation of a source program;
map individual statements of the source program to corresponding portions of the intermediate representation of the source program;
determine a source program line number and at least one user variable for at least one constraint of a plurality of constraints based on the mapping; and
output the source program line number and the at least one user variable for a constraint related to the at least one underperforming portion of the compiled executable file.

25. The computer program product of claim 24, wherein identifying at least one underperforming portion of the compiled executable file comprises identifying a plurality of underperforming portions of the compiled executable file, and wherein the program instructions are further executable to rank the plurality of underperforming portions by determining which of the plurality of underperforming portions of the compiled executable file are causing greater performance issues.
